(19) United States
(12) Patent Application Publication
(10) Pub. No.: US 2010/0013759 A1
(43) Pub. Date: Jan. 21, 2010

(54) KVM SWITCH WITH SEPARATE ON-SCREEN DISPLAY AND CONTROL CHANNELS

(75) Inventor: Hung-June Wu, Pan-Chiao City (TW)

Correspondence Address: JUNE-ON CO., LTD., P.O. BOX 108-00403, TAIPEI 106, TW

(73) Assignee: JUNE-ON CO., LTD., Pan-Chiao City (TW)

(21) Appl. No.: 12/176,426

(22) Filed: Jul. 21, 2008

(51) Int. Cl. G09G 5/00

(52) U.S. Cl. 345/156

(57) ABSTRACT

The present invention relates to a KVM switch with separate on-screen display and control channels, particularly to the KVM switch is connected to a plurality of computers, monitors and operation devices. The KVM switch comprises a switch circuit connected with the computers, a video switch circuit connected with the switch circuit for sending a signal to the monitors, a separate control system connected to the video switch circuit for receiving a function command from the operation devices, and a video control and display unit connected to the separate control system for producing and sending a video signal and synchronous signal to the monitors through the video switch circuit. Because the video control and display unit can transmit the video signal containing OSD (on-screen display) functions and display contents to the video switch circuit through a separate channel, and the separate control system also sends a switching signal to the video switch circuit to shut off the video signal form the computers, therefore, an OSD (on-screen display) image displayed on the monitors has fixed settings and facilitates a user to view and operate.

### BACKGROUND OF THE INVENTION

1. Field of the Invention

The present invention provides a KVM switch with separate on-screen display and control channels, particularly, the KVM switch allowing the OSD (on-screen display) image to be displayed at fixed settings in order to facilitate the user to view and perform operations through the separate control system and the video control and display unit and using the video switch circuit to switch between the OSD (on-screen display) signal and the computer signal.

2. Description of the Related Art

When a computer fails to meet the operational requirements, adding a new computer or continuing to use the obsolete machine is the most considered practice. But under the situations of limited space or not enough budgets, these ideas often never come true. However, following to the rapid development of the electronic information technology, now two (or more) computers, whether new or old, can share one keyboard, mouse, monitor and even one speaker, microphone and any peripheral electronic device simply through connecting in series to a KVM switch. Such that, the user not only gains more workspace and work more efficiently, but also saves the money for purchasing peripheral devices.

The so-called KVM switch is a keyboard, video and mouse switch; in other words, it allows the user to switch displays among multiple computers merely by means of one keyboard, video and mouse set. This not only simplifies the operational equipment under multi-computer environment, but also allows the user to manage different computers or servers synchronously through rapid switching from one computer to another, without interruption of operations of the computer from which the switching is performed, thus making operations easer.

As the KVM switches become popular, the manufactures have developed a KVM switch with On-Screen Display (OSD) functions, which display a control panel on the monitor to facilitate the user to operate and adjust. Referring to FIGS. 3 and 4, a conventional KVM switch with the OSD functions is to insert an OSD video signal into the horizontal/vertical signals of the computer video so that the OSD operation image is directly overlapped on the original computer image. However, because the display settings of each computer are different, the word size or display position of the OSD image will vary from one computer to another. This not only affects the degree of comfort of the user while viewing, but also makes the operations by using a mouse or touch screens more troublesome and difficult.

The KVM switch A comprises a switch circuit A1 that having a control processing chip A11 and a signal switching circuit A12, and on-screen display (OSD) chip A2 connected to the switch circuit A1. The switch circuit A1 is also connected to a plurality of computer connecting interfaces B and a monitor C, and the OSD chip A2 is connected to an operation device D. The control processing chip A11 can carry out the processing/computation to an OSD display and control functions. However, both the size of program memory and the number of I/O pins in the control processing chip A11 limit the OSD display and control functions. Moreover, the execution burden and the share of resources of the control processing chip A11 make the OSD display and control functions only reach the basic effects and the on-line update of the OSD functions is impossible.

As the computer technology advances and the computers are widely used, how to secure the safety of data stored in computers is one of concerns of the users. The OSD display and control functions of the KVM switch A cannot be isolated from the computers, that is, both of them share the same control processing chip A11 and the memory. This leads to incompliance with general NIAP IT security standards and the requirements of human interface Devices (HID). Therefore, it is desirable to provide a KVM switch that eliminates the aforesaid problems.

### SUMMARY OF THE INVENTION

The present invention has been accomplished under the circumstances in view. The primary objective of the present invention is a KVM switch comprising a switch circuit, a video switch circuit, a separate control system and a video control and display unit. The switch circuit, the video switch circuit and the separate control system are connected to a plurality of computers, monitors and operation devices respectively. When receiving a function command from the operation devices, the separate control system converts the function command to a control command and sends to the video control and display unit, then the video control and display unit produces a video signal containing OSD (on-screen display) functions and display contents and a synchronous signal and transmits to the video switch circuit. At the same time, the separate control system sends a switching signal to the video switch circuit to that the video switch circuit can shut off video signals from the computers and output the OSD (on-screen display) video signal from the video control and display unit to the monitors for display. Since the video signal containing the OSD (on-screen display) functions and display contents is transmitted through a separate channel and it has no relationship with the video signals from the computers, therefore, an OSD (on-screen display) image is not affected by the computer settings and has its own fixed resolutions, refresh frequency, word sizes, display position or other display settings, facilitating the user to view or to operate by using a mouse or touch screen.

The second objective of the present invention is that the KVM switch uses the separate control system to separately process/compute to the OSD (on-screen display) functions and uses the video control and display unit to produces the video signal containing the OSD (on-screen display) functions and display contents and the synchronous signal. Besides, the switch circuit uses a control processing chip to separately process/compute to the video signals form the computers. Because the OSD (on-screen display) functions have no relationship with the memory, pin or other resources of the control processing chip, it will not occupy the resources in the control processing chip. Therefore, it reduces the execution burden of the control processing chip. Furthermore, the separate control system can randomly expand or on-line update to the OSD (on-screen display) functions, not only enhancing the OSD (on-screen display) functions, but also making the OSD (on-screen display) functions more complete.

Another objective of the present invention is that the switch circuit and the video control and display unit connected to the separate control system transmit the video signals and synchronous signals via different channels, and the switch circuit and the separate control system use the memory separately. Once the video signal and synchronous signal are transmitted to the video switch circuit, the video switch circuit switches off or on to the video signals between the switch circuit and the video control and display unit according to a switching signal received from the separate control system. So only one of signals is allowed to be sent to the monitors for display. Thus, when the user carries out the operation to the OSD (on-screen display), the OSD (on-screen display) will not be transmitted to the memory of the switch circuit of the computers so that the KVM switch can satisfy to IT security standard and the requirements of the human interface device (HID). Thereby, both the application range and the sales market of the KVM switch of the present invention are expanded.

### BRIEF DESCRIPTION OF THE DRAWINGS

FIG. 1 is a block diagram of a KVM switch in accordance with the present invention.

FIG. 2 is a schematic diagram showing how the KVM switch is used in accordance with the present invention.

FIG. 3 is a block diagram of a KVM switch according to the prior art.

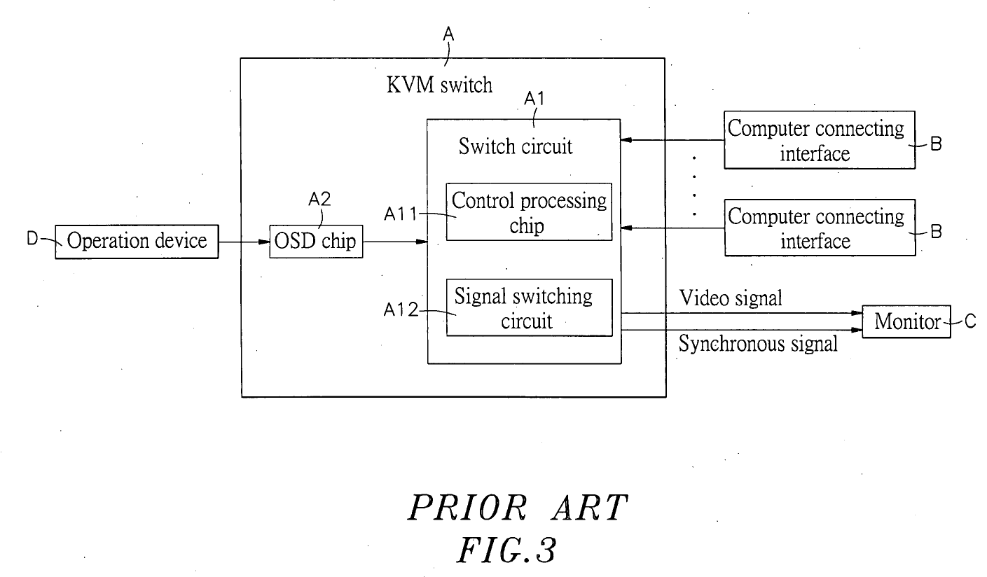

FIG. 4 is a schematic diagram showing how the KVM switch is used according to the prior art.

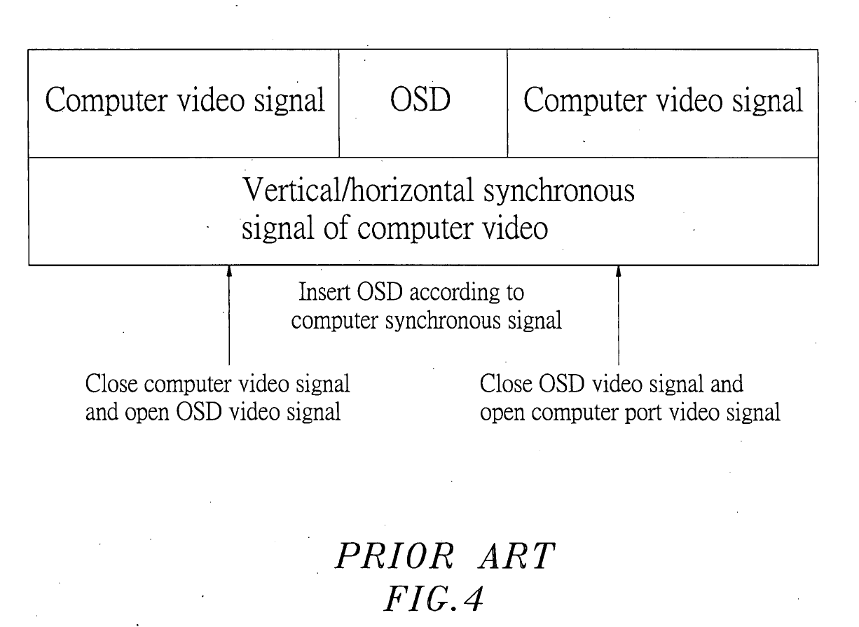

### DESCRIPTION OF THE PREFERRED EMBODIMENT

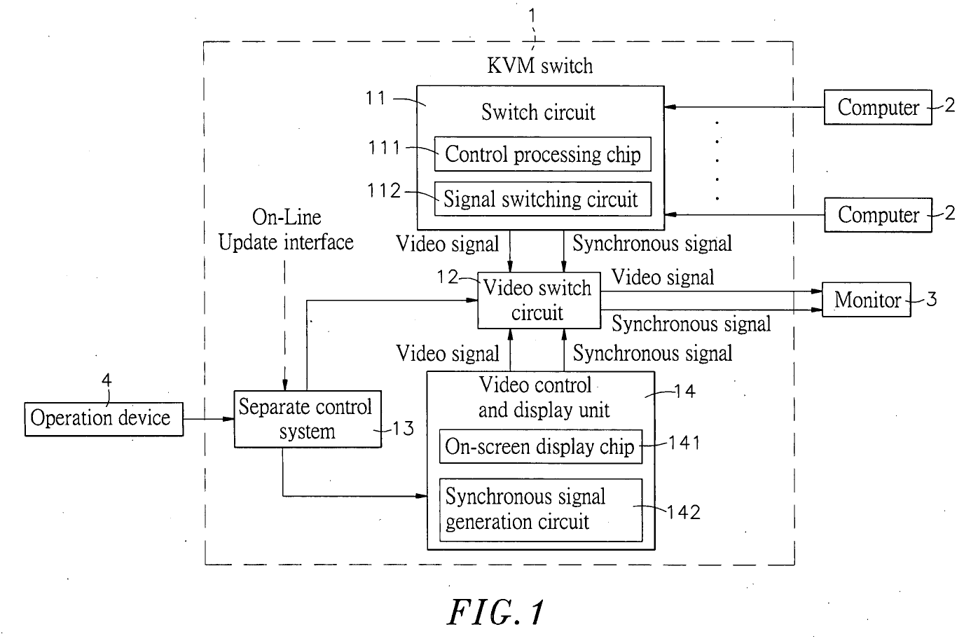

Referring to FIG. 1, a KVM switch 1 in accordance with the present invention is shown comprised of a switch circuit 11, a video switch circuit 12, a separate control system 13 and a video control and display unit 14. The switch circuit 11 can connect with a plurality of computers 2 and has a control processing chip 111 and a signal switching circuit 112. The video switch circuit 12 is connected to the switch circuit 11 and transmits signals to a plurality of monitors 3. The separate control system 13 is connected to the video switch circuit 12 and the video control and display unit 14 respectively and can receive signals from a plurality of operation devices 4, and may be a single chip (MCU), embedded system or other system able to process signals. The video control and display unit 14 is connected to the video switch circuit 12 and comprises an on-screen display chip 141 and a synchronous signal generation circuit 142.

The computers 2 can send a video signal and a synchronous signal to the switch circuit 11 for processing/computing by the control processing chip 111. Then, the computed video signal and synchronous signal are transmitted from the signal switching circuit 112 through the video switch circuit 12 to the monitors 3 for display.

Besides, a user also can use the operation devices 4 to issue a function command to the separate control system 13, and the separate control system 13 converts the received function command into a control command and sends to the video control and display unit 14. Meanwhile, the separate control system 13 sends a switching signal to the video switch circuit 12 to shut off the video signal output from the computers 2, and at the same time, the video signal output from the video control and display unit 14 is started. Since the video control and display unit 14 utilizes the on-screen display chip 141 and the synchronous signal generation circuit 142 to produce a video signal containing OSD (on-screen display) functions and display contents and a constant frequency vertical/horizontal synchronous signal respectively which have no relationship with the video signal of computers 2, so, when the switch circuit 11 is switched to any computer 2, the OSD (on-screen display) displayed on the monitors 3 is fixed in size and position. Therefore, the user not only views conveniently, but also could carry out the operations to the OSD (on-screen display) by using a mouse, touch screen or other operation devices 4.

The operation devices 4 could control the video control and display unit 14 to produce a video signal via the separate control system 13, then, the video control and display unit 14 sends the video signal to the video switch circuit 12. Since the video signal from the video control and display unit 14 displayed on the monitor 3 doesn't overlap with the video signal from the computers 2 connected to the KVM switch 1, therefore, the video signal from the video control and display unit 14 will not be influenced by the video settings of the computers 2 and has a plurality of display settings including fixed resolutions, refresh frequency, word sizes and display position, enabling the user to adjust the desired display settings and store in the separate control system 13. Besides, because the whole OSD (on-screen display) image can be positioned on the monitor, it is easy for the user to set by using a mouse, touch screen or other operation devices 4.

The control processing chip 111 of the switch circuit 11 is used to process/compute to the video signal output by the computers 2, and the separate control system 13 is used to process/compute to the OSD (on-screen display) functions, so the execution burden of the control processing chip 111 is relieved, and the occupation of the memory, pins or other resources in the control processing chip 111 can also be avoided. Moreover, the use of the separate control system 13 can significantly enhance the control function of the OSD (on-screen display) system and allow for random expansion or on-line update to the OSD (on-screen display) functions as well.

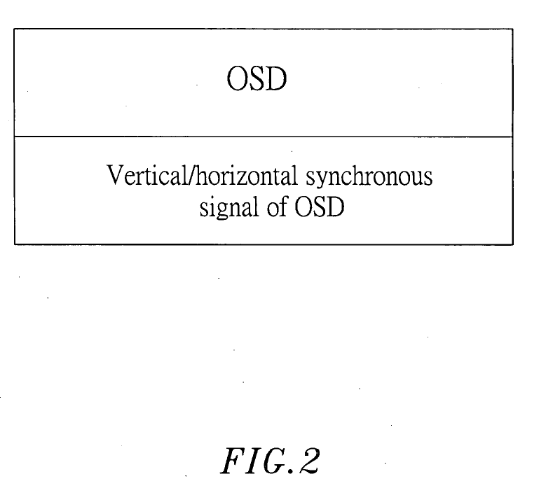

Referring to FIGS. 2 and 1 again, when the user uses the operation devices 4 to start the OSD (on-screen display) functions, the separate control system 13 will send a switching signal to the video switch circuit 12 in order to shut off the video signal and synchronous signal output from the computers 2, and at the same time, the separate control system 13 controls the video control and display unit 14 and the synchronous signal generation circuit 142 to produce a video signal containing the OSD (on-screen display) functions and display contents and a synchronous signal, and then the video switch circuit 12 transmits the OSD (on-screen display) video signal and the synchronous signal to the monitors 3 which can display the whole OSD (on-screen display) image. Because it is impossible to transmit data between the signal transmission channels of the OSD (on-screen display) system and the computers 2, the separate control system 13 and the switch circuit 11 use the memory separately. Thus, when using the operation devices 4 to operate the OSD (on-screen display), the security of the computers 2 will not be influenced, and the IT security standards (e.g., NIAP EAL4 and EAL4+) and the human interface device (HID) are satisfied. Thereby both the application range and the sales market of the KVM switch 1 of the present invention are expanded, that is, the KVM switch 1 can be used for network supervision and national defense as well as in government supervision or places and fields of high confidentiality.

Upon the operation of the OSD (on-screen display) functions completed, the user can use the operation devices 4 to issue a command to separate control system 13 so that the separate control system 13 outputs a switching signal again. After receiving the switching signal, the video switch circuit 12 will shut off the video signal and synchronous signal output from the video control and display unit 14 and start the video signal and synchronous signal output from the computers 2 at the same time. Therefore, the monitors 3 can display the video signal from the computers 2.

The operation device 4 may be a keyboard, mouse, touch screen, Bluetooth interface device, infrared interface device or other devices that enables the user to carry out the operation.

In actual practice, the KVM switch with separate on-screen display and control channels of the present invention has the following features and advantages:

1. After receiving a function command from the operation devices 4, the separate control system 13 converts it into a control command and sends to the video control and display unit 14. Then, the video control and display unit 14 produces a video signal containing OSD (on-screen display) functions and display contents and a synchronous signal and transmits to the video switch circuit 12. At the same time, the separate control system 13 sends a switching signal to the video switch circuit 12 to shut off the video signal output from the computers 2, and the video switch circuit 12 sends the video signal and synchronous signal from the video control and display unit 14 to the monitors 3 for display. Since the video signal containing the OSD (on-screen display) functions and display contents has no relationship with the video signal from the computers 2, the OSD (on-screen display) image can have a plurality of display settings including fixed resolutions, refresh frequency, word sizes and display position, facilitating the user to view the OSD (on-screen display) image or operate.

2. The separate control system 13 is used for processing/computing to the OSD (on-screen display) functions, and the control processing chip 111 is used for processing/computing the video signal from the computers 2. Because the OSD (on-screen display) functions do not occupy the memory, pins or other resources of the control processing chip 111, the execution burden of the control processing chip 111 can reduce. Additionally, the separate control system 13 allows for the random expansion or on-line update of the OSD (on-screen display) functions, not only enhancing the control function of the OSD (on-screen display) system, but also making the OSD (on-screen display) functions more complete.

3. The video signals and synchronous signals from the switch circuit 11 and the video control and display unit 14 are transmitted to the video switch circuit 12 through different channels. Further, the switch circuit 11 and the separate control system 13 use the memory separately. When using the operation devices 4 to operate the OSD (on-screen display), the signal transmission to the switch circuit 11 will not influence the security of the computers 2. This makes the KVM switch 1 in keeping with the IT security standard and the requirement of the human interface device (HID), and thereby the application range of the KVM switch 1 of the present invention expanded.

Therefore, the KVM switch 1 of the present invention comprises a switch circuit 11 for transmitting video signals from a plurality of computers 2, a video switch circuit 12 connected to the switch circuit 11 for receiving a video signal from the switch circuit 11, a video control and display unit 14 connected to the video switch circuit 12, and a separate control system 13 connected to a plurality of operation devices 4 for producing and a control command and a switching signal to the video control and display unit 14 and the video switch circuit 12 respectively. After the video control and display unit 14 produces a video signal and synchronous signal and sends to the video switch circuit 12, the video switch circuit 12 will output the video signal from the switch circuit 11 or from the video control and display unit 14 according to the received switching signal. In this way, the video control and display unit 14 can transmit an OSD (on-screen display) image through the video switch circuit 12 to a plurality of monitors 3 for display, and the OSD (on-screen display) image has a plurality of display settings including fixed resolutions, refresh frequency, word sizes and display position. Thus, the user can use a mouse, touch screen or other operation devices 4 to adjust settings to the OSD (on-screen display) functions.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A KVM switch with separate on-screen display and control channels, said KVM switch capable of connecting with a plurality of computers, monitors, and operation devices, comprising a switch circuit, a video switch circuit, a separate control system and a video control and display unit, wherein:
said switch circuit receives video a signal video and synchronous signal from said computers, and after processing/computing, said video signal and synchronous signal are sent to said video switch circuit;
said video switch circuit can receive video signals and synchronous signals from said switch circuit and said video control and display unit respectively, and switch between said video signals and synchronous signals to allow one of said video signals and synchronous signals to be transmitted to said monitors for display;
said separate control system can receive a function command from said operation devices and convert said function command into a control command, and then send said control command to said video control and display unit, at the same time, send a switching signal to said video switch circuit;
said video control and display unit can receive said control command from said separate control system, and produce and send a video signal containing OSD (on-screen display) functions and display contents and a synchronous signal to said video switch circuit.

2. The KVM switch with separate on-screen display and control channels as claimed in claim 1, wherein said switch circuit comprises a control processing chip for processing to said video signal and synchronous signal from said computers, and a signal switching circuit for switching among said plurality of computers to receive signals.

3. The KVM switch with separate on-screen display and control channels as claimed in claim 1, wherein said separate control system can be a signal chip (MCU) and an embedded system for processing signals.

4. The KVM switch with separate on-screen display and control channels as claimed in claim 1, wherein said video control and display unit comprises an on-screen display chip for producing said video signal containing the OSD (on-screen display) functions and the display contents, and a synchronous signal generation circuit for producing said synchronous signal that is a constant frequency vertical/horizontal synchronous signal.

5. The KVM switch with separate on-screen display and control channels as claimed in claim 1, wherein said operation device can be a keyboard, a mouse, a touch screen, a Bluetooth interface and an infrared interface.

6. The KVM switch with separate on-screen display and control channels as claimed in claim 1, wherein said video signal produced by said video control and display unit has a plurality of display settings including fixed resolutions, refresh frequency, word sizes and display position.
